(19) United States
(12) Patent Application Publication
(10) Pub. No.: US 2023/0404236 A1
(43) Pub. Date: Dec. 21, 2023

(54) HANDHELD APPLIANCE

(71) Applicant: Dyson Technology Limited, Wiltshire (GB)

(72) Inventors: Stephen Benjamin COURTNEY, Gloucester (GB); Robert Mark Brett COULTON, Bristol (GB); Alexander Edward HUGHES, Swindon (GB)

(73) Assignee: Dyson Technology Limited, Wiltshire (GB)

(21) Appl. No.: 18/028,247

(22) PCT Filed: Sep. 6, 2021
(86) PCT No.: PCT/GB2021/052287

§ 371 Date: Mar. 24, 2023

(30) Foreign Application Priority Data
Sep. 30, 2020 (GB) 2015483.7

(51) Int. Cl. A45D 20/12

(52) U.S. Cl. CPC A45D 20/12

(57) ABSTRACT

A handheld appliance has a handle, the handle having a main body, the main body having a first end portion, a second end portion and a third portion there between, wherein the first end portion and the second end portion extend radially outwards beyond the third portion; and an external sleeve is rotatably supported around the third portion by the first end portion and the second end portion.

### FIELD OF THE INVENTION

This invention relates to a handle for a hand held appliance, in particular a hair care appliance such as a hot styling appliance.

### BACKGROUND OF THE INVENTION

A hair styling device is often rotated to create a desired style. To avoid twisting of a power cable of the device, the power cable may be rotatably connected with respect to a handle of the device. However, a rotatable connection for a hair styling device that uses an eight wire power cable may be fragile and prone to breaking which could result in a poor connection.

### SUMMARY OF THE INVENTION

Accordingly, the invention provides a handle for a handheld appliance, the handle comprising: a main body comprising: a first end portion connectable to, or comprising, a power supply; a second end portion; and a third portion therebetween, wherein the first end portion and the second end portion extend radially outwards beyond the third portion; and an external sleeve configured to be gripped by a user to support the handle during use of the appliance, the external sleeve being rotatably supported around the third portion by the first end portion and the second end portion. This enables a user to rotate a hand used to support the appliance without rotating the main body of the appliance.

The sleeve may be continuously rotatable with respect to the main body. This provides the user with 360 degree rotatability of the device such that their hand may be positioned at any degree of rotation without rotating the main body of the appliance.

The handle may comprise a power cable fixedly connected to the first end portion of the main body. This ensures the power cable is connected to a stationary part of the main body. Thus, the cable is not put under strain as the user twists the hand used to support the appliance.

The sleeve may axially extend the length of the third portion of the main body such that a first edge of the sleeve abuts the first end portion of the main body and a second edge of the sleeve abuts the second end portion of the main body. This has the effect that components housed in the third portion are protected by the external sleeve.

An outer surface of the sleeve may lie flush with at least an adjoining section of an outer surface of the first end portion of the main body. This improves an aesthetic of the handle and provides a smooth external surface to the appliance to avoid snagging on any protruding edges.

The third portion of the main body and the sleeve may be substantially cylindrical. Allowing for easy rotation of the sleeve around the main body.

The handle may be configured to receive a removable attachment.

The sleeve may comprise at least part of an attachment mechanism for attaching the removable attachment. This may provide an arrangement wherein, when the user rotates the sleeve with respect to the main body, the attachment is also rotated to achieve desired styling of a user's hair.

The main body may house a fan unit and a heater.

The first end portion of the main body may further comprise at least one user operated button. The user operated button may control temperature settings or flow settings of the appliance.

The second end portion of the main body may comprise an air outlet of the handle.

The handle may further comprise a switch. The switch may be located at least partially on the sleeve. The switch may be in the form of an at least partially annular collar which extends at least partially around the sleeve. The collar may be continuously annular, and so may surround the sleeve. The switch may be configured to rotate with the sleeve around the main body and to slide axially with respect to both the sleeve and the main body. This allows the user to switch between different modes of operation, and/or control settings, of the appliance when the sleeve is rotated at any orientation and ensures that switching between different modes of operation of the appliance does not inhibit rotation of the sleeve.

The handle may further comprise at least one collar spacer attached to an inner surface of the collar. The at least one collar spacer may extend through a corresponding aperture of the sleeve and may be axially retained between support rings which extend circumferentially around the main body. The support rings may be configured to slide axially with the collar. This arrangement provides the functionality whereby the collar may rotate with the sleeve whilst simultaneously being moveable relative to the sleeve between axial positions.

The support rings may be coupled to an arm of an actuator such that axial movement of the collar actuates the actuator. Thus, moving the collar between axial positions activates different modes of the appliance, for example, a deactivated “OFF” mode, an activated “ON” mode and a “cool shot” mode wherein air flows through the device without being heated.

The third portion of the main body may be configured to prevent circumferential rotation of one or both of the actuator arm and support rings. The third portion of the main body may comprise a recess shaped to accommodate the actuator arm. This ensures that engaging elements of the actuator remain aligned upon rotation of the sleeve.

The at least one collar spacer may comprise a plurality of collar spacers circumferentially spaced around the inner surface of the collar. This ensures a distribution of the axial force applied by the user onto the collar and connected parts to ensure a minimum strain on said parts.

The at least one corresponding aperture in the sleeve may be configured to abut sides of the at least one corresponding collar spacer in the circumferential direction and configured to allow axial movement of the at least one collar spacer within the sleeve. This arrangement ensures that the collar may move axially without being impeded by the external sleeve whilst also ensuring that the collar rotates in unison with the sleeve.

The collar may have a plurality of axial positions. Each axial position of the collar may correspond to a different operational state of the appliance.

Dimensions of the at least one corresponding aperture in the sleeve may be such that the collar is axially moveable between the plurality of axial positions.

The plurality of axial positions may comprise three axial positions corresponding to three different operational states, wherein the three different operational states are on with a heater engaged, off and on with the heater disengaged.

The appliance may be a hair care appliance. The hair care appliance may be a hot styling appliance.

### BRIEF DESCRIPTION OF THE DRAWINGS

Preferred features of the present invention will now be described by way of example only with reference to the accompanying drawings, in which:

FIG. 1 is a right side, front perspective view of an handle;

FIG. 2 is a left side, rear perspective view of the handle;

FIG. 3 is a front view of the handle with an attached removable attachment;

FIG. 4 is an enlarged side view of part of the handle with a collar removed;

FIG. 5 is an enlarged side view of part of the handle with the collar and an external sleeve removed;

FIG. 6 is a cross section of the handle taken along line A-A of FIG. 2; and

FIG. 7 is an enlarged view of section B of FIG. 6 showing a spring ball actuator.

### DETAILED DESCRIPTION OF THE INVENTION

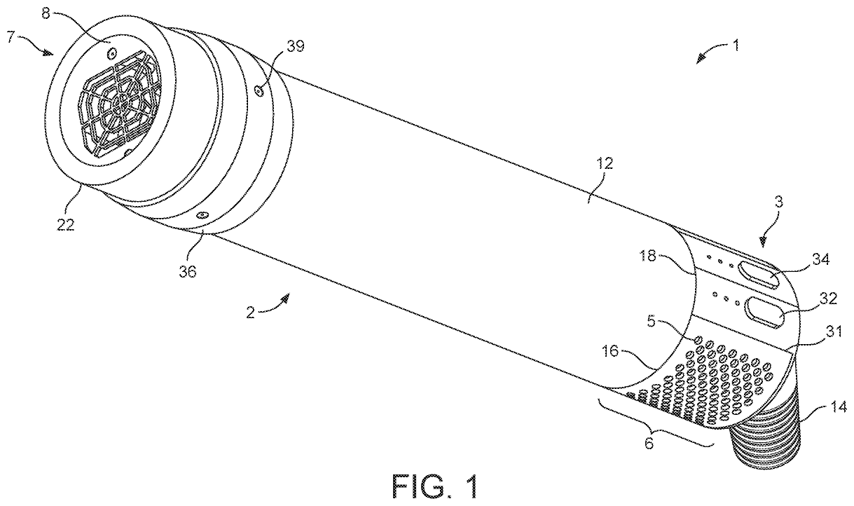

As illustrated by FIGS. 1 to 5, a handle 1 for a hairstyling appliance has a main body 4 and a substantially cylindrical external sleeve 12. The main body 4 has a first end portion 6, a second end portion 8 and a third portion 10 wherein the third portion 10 is substantially cylindrical.

The first end portion 6 is at a first end 3 of the handle 1. The first end portion 6 has a larger diameter than the third portion 10 such that a ledge 29 is provided between the first end portion 6 and the third portion 10. The first end portion 6 includes a user interface 31 with user operated buttons to control aspects of the appliance in use. The user interface 31 has two user operated buttons: a first user operated button 32 to control a temperature of an air flow through the appliance and a second user operated button 34 to control a flow rate of the air flow through the appliance.

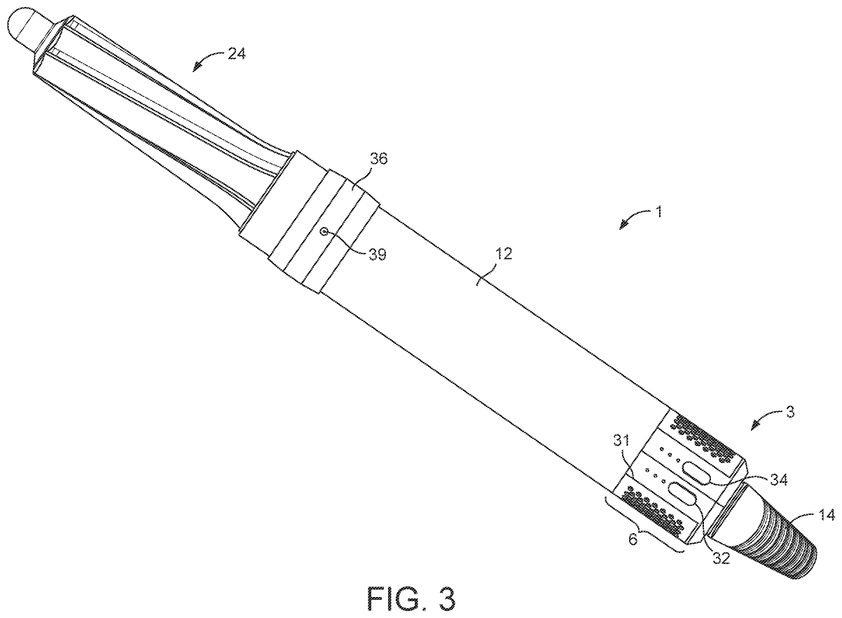

The second end portion 8 of the main body 4 consists of an exit grille. The exit grille provides an air outlet for air flow through the handle 1 which enters the handle 1 through air inlet 5 proximate to the first end 3 of the handle 1. As illustrated in FIG. 3, when a removable attachment 24 is attached to the handle 1, air exiting the exit grille enters the removable attachment 24 and exits through air outlets in the attachment 24. The exit grille has a larger diameter than the third portion 10 of the main body 4 to provide a further ledge 26.

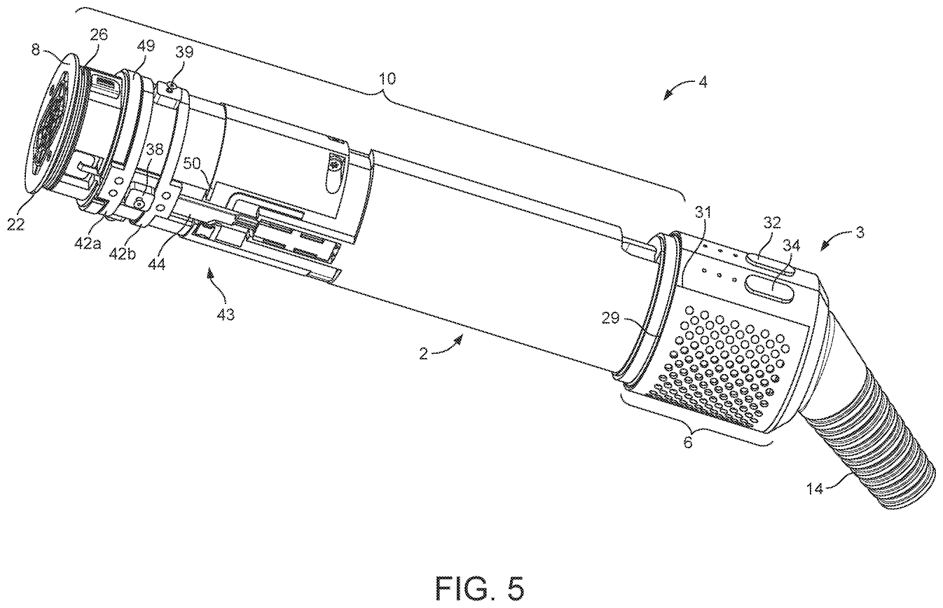

An external sleeve 12 is positioned between the first end portion 6 and the second end portion 8 of the main body 4 and circumferentially surrounds a third portion 10 of the main body 4. The third portion 10 of the main body is shown in FIG. 5 which illustrates the handle 1 without the external sleeve 12. The sleeve 12 is supported between the two ledges 29, 26 created by the diameter difference between the first end portion 6, second end portion 8 and third portion 10 of the main body 4.

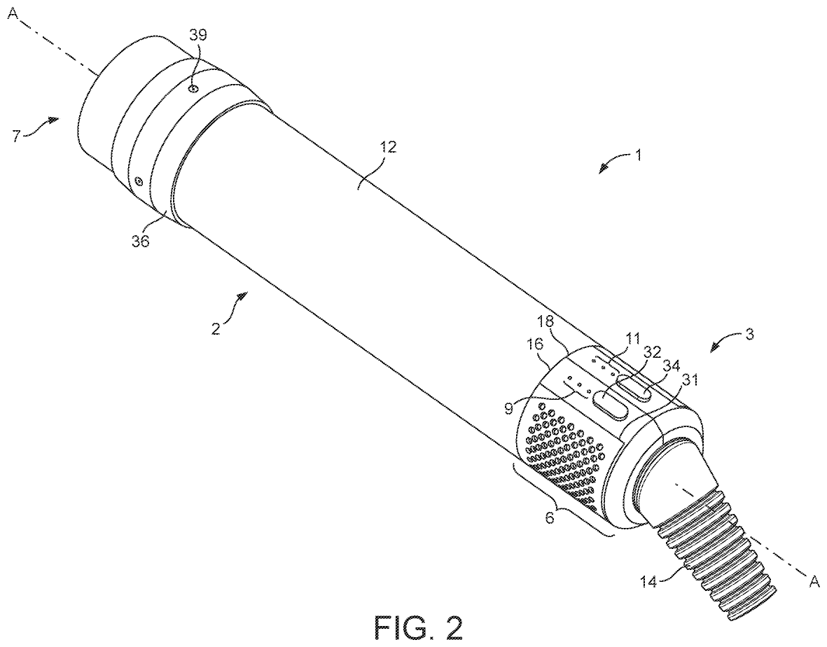

As illustrated in FIGS. 1 and 2, the diameter of the first end portion 6, second end portion 8 and the external sleeve 12 are substantially the same such that an external surface of the handle is continuous and without protruding sections. A first edge 16 of the external sleeve 12 is contiguous with an edge 18 of the first end portion 6 of the main body 4. A second edge of the external sleeve 12 may also be contiguous with an edge 22 of the exit grille. The first edge 16 of the external sleeve 12 can slide circumferentially with respect to the edge 18 of the first end portion 6 of the main body 4 without meeting any obstructions. Similarly, a second edge of the external sleeve 12 may be slidable circumferentially with respect to an edge 22 of the exit grille without meeting any obstructions. Thus, the external sleeve 12 may be continuously rotatable with respect to the main body 4.

The external sleeve 12 further comprises a collar 36. The collar 36 is configured to rotate with the external sleeve 12 but may also be shifted axially with respect to the external sleeve 12 and the main body 4. The collar 36 provides a user operated switch wherein axial positions of the collar 36 represent different setting of the appliance. For example, the collar 36 may be axially movable into three distinct positions wherein the appliance is, respectively, OFF in a first positions, ON (with the heater engaged) in a second position and ON (with the heater 30 disengaged) in a third position. Changing the setting of an appliance such that a heater is disengaged is known in the art as a “cool shot”. Preferably, the collar is made of metal for a greater aesthetic appearance.

In use, a user may often rotate a hand they are using to support the handle 1 in order to orientate an attached attachment with respect to their hair during styling, for example, to encourage the hair to wrap around the attachment. The appliance may be connected to a power supply via the power cable 14. The power cable 14 of the appliance is an eight wire power cable which provides power and communication signals to an electric box which houses a majority of the electronics of the appliance. Thus, fewer electronic components are accommodated in the main body 4 resulting in a reduced size of the main body 4. The eight wire power cable 14 is heavier and has a larger diameter in comparison to power cables comprising a lower number of wires, for example, a standard two-wire power cable. As a result, a rotatable connection between the power cable 14 and the main body 4 of the handle 1 would be fragile and prone to breaking, risking a power connection failure in the appliance. The power cable 14 is, therefore, fixedly connected to the first end portion 6 of the non-rotatable main body 4 of the handle 1. To ensure that the user is still able to rotate their hand and an attached attachment without twisting the power cable 14, the external sleeve 12, including the collar 36, rotates with respect to the main body 4, to which the power cable 14 is fixedly attached. Thus, the user is able to orientate the attachment 24 without risk of damage to the power cable 14 connection of the eight wire power cable 14.

FIG. 3 shows the handle 1 together with removable attachment 24. In this example, the attachment 24 is tubular and is designed for styling curls, however, the attachment 24 may be any other hair styling attachment configured to attach to an attachment mechanism on the handle 1. An air inlet of the attachment is connected to the exit grille of the handle 1 and receives the air drawn in by the action of a motor. The air then exits the attachment 24 via air outlets in the attachment 24.

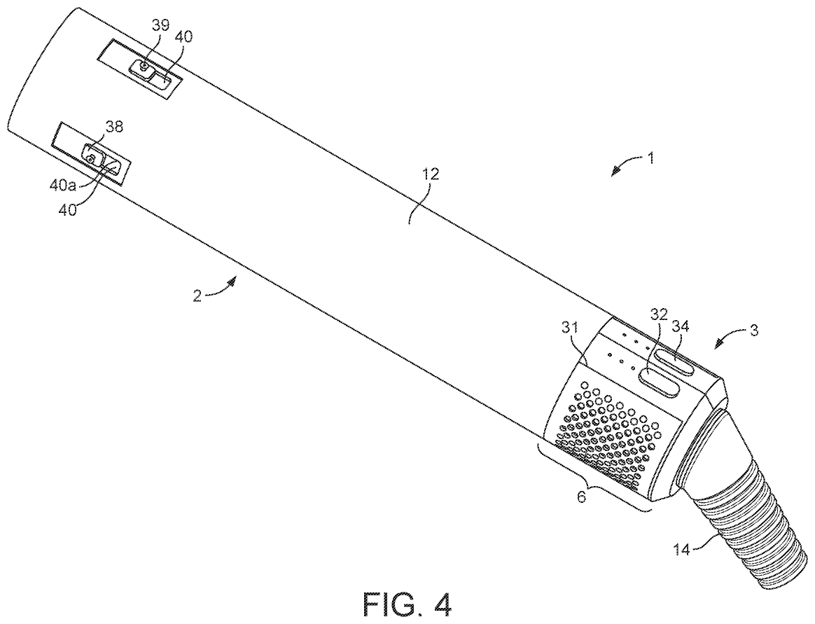

As illustrated by FIG. 4, the sleeve 12 further comprises apertures, or slots, 40. The slots 40 retain collar spacers 38. In the particular example of the Figures, each of the collar spacers 38 is secured to an inside surface of the collar 36 by a screw 39. In an alternative embodiment, the collar spacers 38 may be integrally formed with the collar 36, for example, by an injection molding process.

As further illustrated in FIG. 4, circumferential sides of the collar spacers 38 are contiguous with circumferential edges 40a of the slots 40, whereas an axial height of the slots is greater than the axial height of the collar spacers 38 to allow axial movement of the collar spacers 38 within the respective slots 40.

Preferably, four evenly, circumferentially spaced collar spacers 38 extend through four corresponding apertures 40 providing four evenly spaced connection points between the collar 36 and the support rings 42. This evenly distributes the force applied to the connection points when the user applies an axial force to move the collar 36 between axial positions. This protects the collar 36, support rings 42, screws 39 and collar spacers 38 and leads to an improved durability of these elements of the handle 1.

FIG. 5 shows the main body 4 of the handle 1 with the collar 36 and the external sleeve 12 removed to show the supports rings 42 and an actuator 43. The support rings 42 concentrically surround the third portion 10 of the main body 4 and are fixedly attached to an actuator arm 44 of the actuator 43. The support rings 42 are separated by a distance equal to the axial height of the collar spacers 38 in order to retain the collar spacers 38 in the axial direction. This arrangement allows the collar spacers 38 to slide circumferentially between the support rings 42 whilst allowing a transfer of axial force from the collar spacers 38 to the support rings 42 to move the support rings 42 axially with respect to the main body 4. Thus, when a user moves the collar 36 in the axial direction, the axial force is transferred through the screws 39 to the collar spacers 38 to the support rings 42 and finally to the actuator arm 44 which actuates the actuator 43.

Retaining ring 49 is fixedly attached to the main body 4 and prevents the supports rings 42 rotating circumferentially with rotation of the sleeve 12 or collar 36 by providing an obstruction in the circumferentially direction against a part of the support rings 42, wherein the part of the support rings extends axially. Furthermore, the actuator arm 44 is housed within recess 50 to prevent rotation of the actuator arm and to also allow for a tight fit between the external sleeve 12 and an external surface of the third portion of the main body 4. This avoids wasted volume between the two components to ensure a minimum total volume of the handle 1.

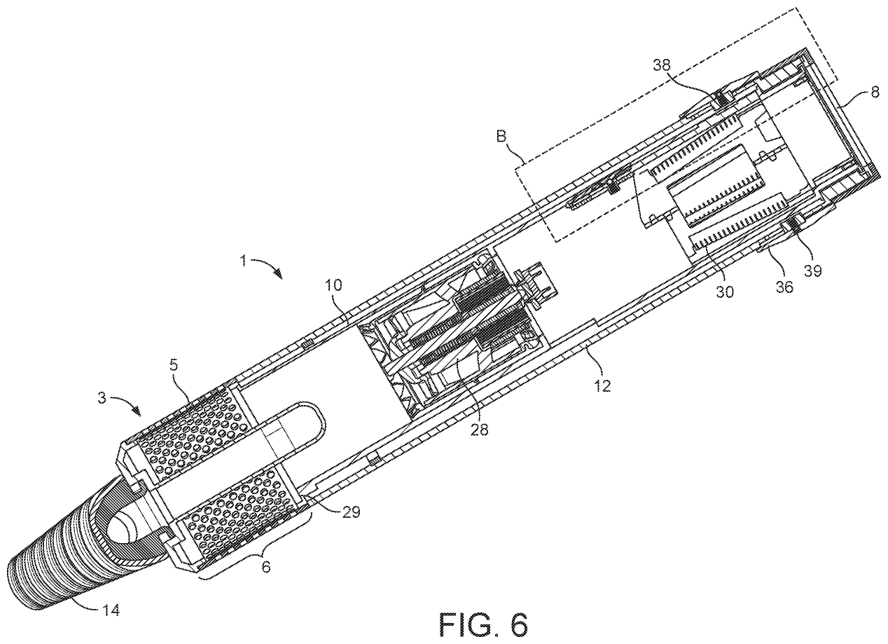

FIG. 6 is a cross section of the handle 1 taken along line A-A of FIG. 2 and shows a fan unit 28 comprising a fan and a motor. In use, the motor drives the fan and air is drawn in through apertures of the air inlet 5, along an air flow path which extends through the main body 4 along the length of the handle 2. The flow rate of the fan is controlled by the flow rate control user operated button 34 on the user interface 31. The flow rate control may have several settings, for example the flow rate control may have three settings: high, medium and low. These settings may be indicated by illumination of LEDs 11 on the first end portion of the main body 4. The air is optionally heated by a heater 30 before exiting the handle 1 at the air outlet consisting of the exit grille. A temperature of the air is controlled by the temperature control user operated button 32 on the user interface 31. The temperature control may have several settings, for example the temperature control may have three settings: high, medium and low. These settings may be indicated by illumination of LEDs 9 on the first end portion of the main body 4.

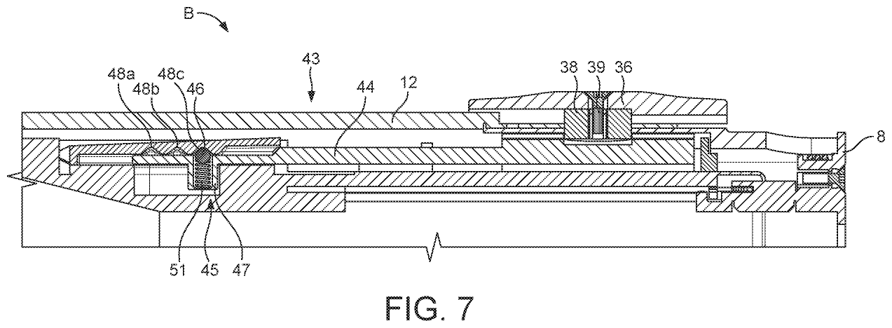

Section B of FIG. 6 is enlarged in FIG. 7 and shows a cross section of the actuator 43 situated within the recess 50 of the third portion 10 of the main body 4. The actuator 43 comprises: the actuator arm 44, a spring ball plunger 45 and an opposite face plate with a plurality of detents 48a, 48b, 48c. The detents 48a, 48b, 48c are configured to accommodate a ball 46 of the spring ball plunger 45 when the actuator arm 44 moves between different axial positions. The actuator arm 44 comprises a housing 47 which extends radially inwards to accommodate a spring 51 of the spring ball plunger 45. The recess 50 within the third portion 10 of the main body 4 extends further radially inward to accommodate the housing 47 and allow movement of the housing 47 as a result of changing the axial positions of the collar 36, as illustrated in FIG. 6. The spring 52 biases the ball 46 into one of the three detents 48a, 48b, 48c until a further axial movement of the collar 36 occurs.

The spring 51 has a length and an elasticity to bias the ball 46 outward to the extent that it contacts an inner surface of the detents 48a, 48b, 48c. When the user slides the collar 36 axially to the next lateral position, the ball 46 is pushed into the housing 47 against an elastic force of the spring 51 and is moved to the next detent 48a, 48b, 48c whereby the spring 51 relaxes, allowing the ball 46 to contact an inner surface of the adjacent detent 48a, 48b, 48c. The three detents 48a, 48b, 48c operate three operative states of the appliance: off, on with the heater 30 engaged and on with the heater 30 disengaged.

1. A handle for a handheld appliance, the handle comprising:
a main body comprising:
a first end portion connectable to, or comprising, a power supply;
a second end portion; and
a third portion therebetween, wherein the first end portion and the second end portion extend radially outwards beyond the third portion; and
an external sleeve configured to be gripped by a user to support the handle during use of the appliance, the external sleeve rotatably supported around the third portion by the first end portion and the second end portion.

2. The handle according to claim 1, wherein the sleeve is continuously rotatable with respect to the main body.

3. The handle according to claim 1, further comprising a power cable fixedly connected to the first end portion of the main body.

4. The handle according to claim 1, wherein the sleeve axially extends the length of the third portion of the main body such that a first edge of the sleeve abuts the first end portion of the main body and a second edge of the sleeve abuts the second end portion of the main body.

5. The handle according to claim 1, wherein an outer surface of the sleeve lies flush with at least an adjoining section of an outer surface of the first end portion of the main body.

6. The handle according to claim 1, wherein the third portion of the main body and the sleeve are substantially cylindrical.

7. The handle according to claim 1, wherein the handle is configured to receive a removable attachment.

8. The handle according to claim 7, wherein the sleeve comprises at least part of an attachment mechanism for attaching the removable attachment to the handle.

9. The handle according to claim 1, wherein the main body houses a fan unit and a heater.

10. The handle according to claim 9, wherein the first end portion of the main body further comprises at least one user operated button.

11. The handle according to claim 10, wherein the user operated button controls temperature settings or flow settings of the appliance.

12. The handle according to claim 9, wherein the second end portion of the main body comprises an air outlet of the handle.

13. The handle according to claim 1, further comprising a switch in the form of an at least partially annular collar, the collar surrounding the sleeve.

14. The handle according to claim 13, wherein the collar is configured to rotate with the sleeve around the main body and to slide axially with respect to both the sleeve and the main body.

15. The handle according to claim 14, further comprising at least one collar spacer attached to an inner surface of the collar, wherein the at least one collar spacer extends through a corresponding aperture of the sleeve and is axially retained between support rings, wherein the support rings extend circumferentially around the main body.

16. The handle according to claim 15, wherein the support rings are configured to slide axially with the collar.

17. The handle according to claim 16, wherein the support rings are coupled to an arm of an actuator such that axial movement of the collar actuates the actuator.

18. The handle according to claim 17, wherein the third portion of the main body is configured to inhibit circumferential rotation of one or both of the actuator arm and support rings.

19. The handle according to claim 16, wherein the third portion of the main body comprises a recess shaped to accommodate the actuator arm.

20. The handle according to claim 15, wherein the at least one collar spacer comprises a plurality of collar spacers circumferentially spaced around the inner surface of the collar.

21. The handle according to claim 15, wherein the at least one corresponding aperture in the sleeve is configured to abut sides of the at least one corresponding collar spacer in the circumferential direction and configured to allow axial movement of the at least one collar spacer within the sleeve.

22. The handle according to claim 14, wherein the collar has a plurality of axial positions.

23. The handle according to claim 22, wherein each axial position of the collar corresponds to a different operational state of the appliance.

24. The handle according to claim 22, wherein dimensions of the at least one corresponding aperture in the sleeve are such that the collar is axially moveable between the plurality of axial positions.

25. The handle according to claim 22, wherein the plurality of axial positions comprises three axial positions each corresponding to a respective different operational state, wherein the three different operational states are on with a heater engaged, off, and on with the heater disengaged.

26. The handle according to claim 1, wherein the appliance is a hair care appliance.
